(19) United States
(12) Patent Application Publication
(10) Pub. No.: US 2013/0329468 A1
(43) Pub. Date: Dec. 12, 2013

(54) SWITCHING CONTROLLER WITH CLAMP CIRCUIT FOR CAPACITOR-LESS POWER SUPPLIES

(71) Applicant: SYSTEM GENERAL CORP., Taipei Hsien (TW)

(72) Inventor: TA-YUNG YANG, MILPITAS, CA (US)

(21) Appl. No.: 13/910,260

(22) Filed: Jun. 5, 2013

Related U.S. Application Data
(60) Provisional application No. 61/656,102, filed on Jun. 6, 2012.

(51) Int. Cl. H02M 3/335

(52) U.S. Cl. CPC H02M 3/33523; H02M 3/33507
USPC 363/21.15

(57) ABSTRACT

A control circuit of a power converter according to the present invention comprises a switching circuit and a sample circuit. The switching circuit generates a switching signal in accordance with a feedback signal and a sampled signal. The switching signal is coupled to switch a transformer of the power converter for regulating an output of the power converter. The feedback signal is generated in accordance with the output of the power converter. The sample circuit generates the sampled signal by sampling a signal of the transformer. The sampled signal is correlated to an output voltage of the power converter.

### REFERENCE TO RELATED APPLICATION

This application is based on Provisional Application Ser. No. 61/656,102, filed 6 Jun. 2012, currently pending.

### BACKGROUND OF THE INVENTION

1. Field of the Invention

The present invention is related to a control circuit, and more particularly, the present invention relates to a control circuit of the power converter.

2. Description of the Related Art

FIG. 1 shows a circuit diagram of an off-line power converter with a small input capacitor 45. A bridge rectifier 40 converts an AC input voltage V_{AC} to a DC input voltage V_{IN}. The small input capacitor 45 is coupled to an output terminal of the bridge rectifier 40. The small input capacitor 45 is utilized to store the energy for providing the input voltage V_{IN} for a transformer 10 of the power converter. The power converter with the small input capacitor 45 will result a higher output line ripple. However, the power converter with the small input capacitor 45 can achieve lower cost and small size.

A control circuit 80 generates a switching signal S_{W} coupled to switch the transformer 10 via a power transistor 20. The transformer 10 has a primary winding N_{P}, a secondary winding N_{S}, and an auxiliary winding N_{A}. A first terminal of the primary winding N_{P} is coupled to the small input capacitor 45 for receiving the input voltage V_{IN}. The power transistor 20 is coupled to a second terminal of the primary winding N_{P} to switch the transformer 10 for transferring the energy from the primary winding N_{P} to the secondary winding N_{S} and the auxiliary winding N_{A}.

A switching current I_{P} flowed through the primary winding N_{P} of the transformer 10 generates a current-sense signal V_{CS} via a current-sense device, such as a resistor 30. The current-sense device is coupled between the power transistor 20 and a ground in series. The current-sense device is further coupled to the control circuit 80. Thus, the control circuit 80 receives the current-sense signal V_{CS}. The auxiliary winding N_{A} of the transformer 10 is coupled to the control circuit 80 through a voltage divider developed by resistors 31 and 32 for generating a reflected signal V_{S}. The switching signal S_{W} is adjusted in accordance with a feedback signal V_{FB} for regulating the output of the power converter.

A resistor 61, a voltage-regulator 70, an opto-coupler 75, and the control circuit 80, etc. develop a feedback loop. A first terminal of the resistor 61 is coupled to an output terminal of the power converter. The voltage-regulator 70 is coupled between a second terminal of the resistor 61 and the opto-coupler 75. The opto-coupler 75 is further coupled to the output terminal of the power converter and the control circuit 80. The feedback signal V_{FB} is generated at an output terminal of the opto-coupler 75. Thus, the control circuit 80 receives the feedback signal V_{FB}. The voltage-regulator 70 is a zener diode according to one embodiment. The feedback signal V_{FB} is coupled to the output terminal of the power converter through the resistor 61, the voltage-regulator 70, and the opto-coupler 75. A rectifier 50 and a capacitor 51 are coupled to the secondary winding N_{S} of the transformer 10 for generating an output voltage V_{O} of the power converter.

Refer to an output power P_{O} of the power converter, it can be expressed as,

$$\begin{matrix}P = \frac{1}{2} \times {L}_{P} \times {I}_{P}^{2} \times {F}_{W} \\ {I}_{P} = \frac{{V}_{IN} \times {T}_{ON}}{{L}_{P}} \\ {P}_{O} = {V}_{O \times } {I}_{O} = \frac{{V}_{IN}^{2} \times {T}_{ON}^{2}}{2 \times {L}_{P} \times T} & ( 1 ) \\ {P}_{O} = {V}_{O \times } {I}_{O} = \frac{{V}_{IN}^{2} \times {T}_{ON}^{2}}{2 \times {L}_{P} \times T} + [ {V}_{IN} \times {I}_{A} \times ( \frac{{T}_{ON}}{T} ) ] & ( 2 )\end{matrix}$$

Where V_{IN} is the level of the input voltage V_{IN}; T_{ON} is the on-time of the switching signal S_{W}; L_{P} is the inductance of the primary winding N_{P} of the transformer 10; T is the switching period of the switching signal S_{W}; F_{W} is the switching frequency of the switching signal S_{W}; the current I_{A} represents a continuous current (energy) existed in the transformer 10 when the next switching cycle is started.

Refer to the output power P_{O} of the power converter operated in discontinuous-current mode (DCM) and/or boundary-current mode (BCM), it is expressed in the equation (1). Refer to the output power P_{O} of the power converter operated in continuous-current mode (CCM), it is shown in the equation (2).

For the most of the power converters, the maximum on-time T_{ON} of the switching signal S_{W} is limited to prevent the saturation of the transformer 10. Thus, the output power P_{O} of the power converter will be limited once the input voltage V_{IN} becomes low, which will result a higher output ripple (line ripple). As shown in FIG. 2, when the output voltage V_{O} becomes lower in response to the lower voltage of the input voltage V_{IN}, the feedback signal V_{FB} will be increased to increase the on-time T_{ON} of the switching signal S_{W} and the output power P_{O}. However, in general, the circuit includes a low-pass filtering (such as the voltage-regulator 70 shown in FIG. 1 includes the low-pass filtering) for the frequency compensation to stabilize the feedback loop, which will cause a low loop response and generate the overshoot for both the feedback signal V_{FB} and the output voltage V_{O}. This overshoot phenomenal will make the output ripple be higher as shown in FIG. 2.

Accordingly, the present invention provides a control circuit with the clamp for the power converter with small input capacitor or no input capacitor to reduce the output ripple.

### BRIEF SUMMARY OF THE INVENTION

The objective of the present invention is to provide a control circuit for the power converter with small input capacitor or no input capacitor to reduce the output ripple.

The control circuit for a power converter according to the present invention comprises a switching circuit and a sample circuit. The switching circuit generates a switching signal coupled to switch a transformer of the power converter for regulating an output of the power converter in accordance with a feedback signal and a sampled signal. The sample circuit generates the sampled signal by sampling a signal of the transformer. The feedback signal is generated through an opto-coupler in accordance with the output of the power converter. The sampled signal is correlated to an output voltage of the power converter. Further, the feedback signal can be generated through an error amplifier and a low-pass filter in accordance with the output of the power converter.

### BRIEF DESCRIPTION OF ACCOMPANIED DRAWINGS

The accompanying drawings are included to provide further understanding of the invention, and are incorporated into and constitute a part of this specification. The drawings illustrate embodiments of the invention and, together with the description, serve to explain the principles of the invention.

FIG. 1 shows a circuit diagram of an off-line power converter with small input capacitor.

FIG. 2 shows the waveforms of the input voltage V_{IN}, the feedback signal V_{FB}, and the output voltage V_{O} in accordance with the conventional off-line power converter.

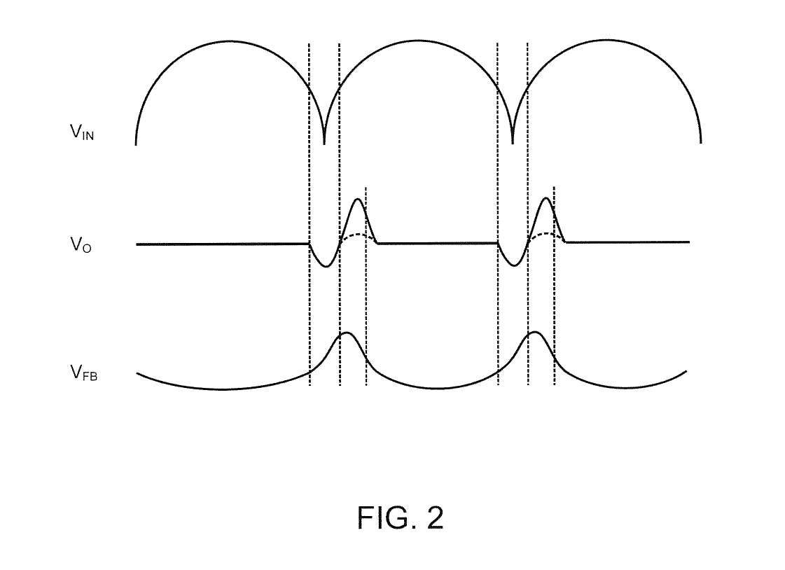

FIG. 3 is a circuit diagram of an embodiment of the control circuit in accordance with the present invention.

FIG. 4 shows the signal waveforms of a sample circuit of the control circuit in accordance with the present invention.

FIG. 5 shows a circuit diagram of an embodiment of a detection circuit of the control circuit in accordance with the present invention.

FIG. 6 shows a circuit diagram of an embodiment of a maximum-duty circuit of the control circuit in accordance with the present invention.

FIG. 7 shows a circuit diagram of an embodiment of a pulse generator of the control circuit in accordance with the present invention.

FIG. 8 shows the signal waveforms of the switching signal S_{W} and the output voltage V_{O}.

FIG. 9 shows a circuit diagram of applying the control circuit in accordance with the present invention to a primary-side controlled power converter with small input capacitor.

FIG. 10 shows a circuit diagram of an embodiment of the control circuit applied to the primary-side controlled power converter with small input capacitor in accordance with the present invention.

### DETAILED DESCRIPTION OF EMBODIMENTS

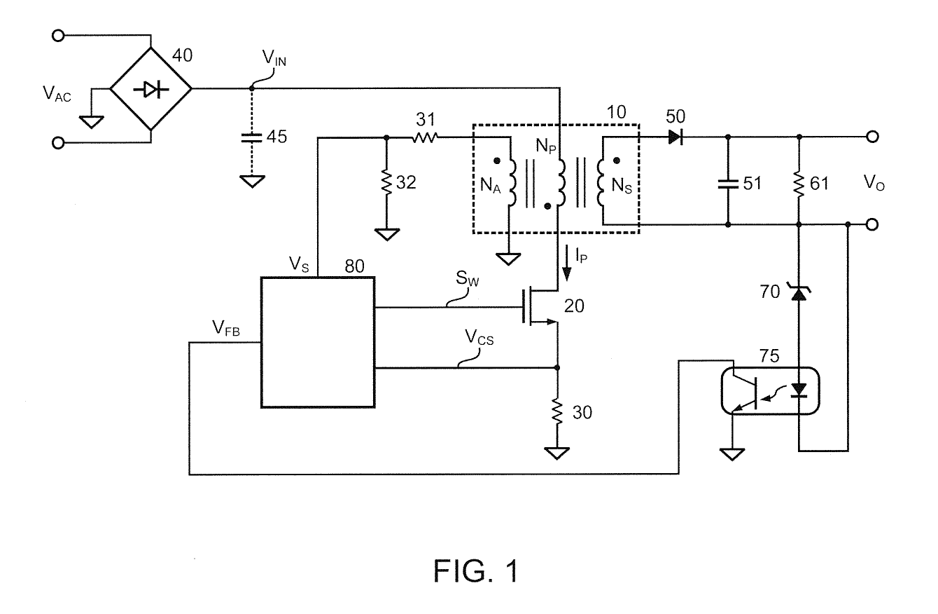

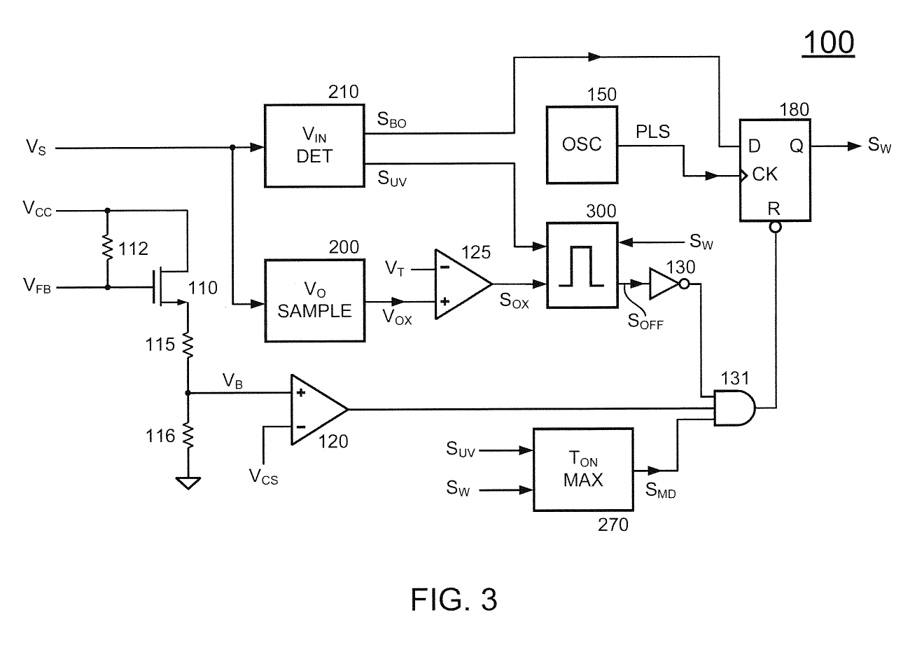

FIG. 3 is a circuit diagram of an embodiment of the control circuit according to the present invention. The control circuit 100 of the present invention replaces the control circuit 80 shown in FIG. 1. The control circuit 100 can be used for the power converter with the small input capacitor 45 shown in FIG. 1 or the power converter without the input capacitor. A transistor 110 and resistors 112, 115, 116 develop a level-shift circuit. The level-shift circuit is coupled to receive the feedback signal V_{FB} and generate a signal V_{B}. A drain of the transistor 110 is coupled to a supply voltage V_{CC}. A first terminal of the resistor 112 is coupled to the supply voltage V_{CC} and the drain of the transistor 110. A second terminal of the resistor 112 is coupled to a gate of the transistor 110 and the feedback signal V_{FB}. The gate of the transistor 110 is further coupled to receive the feedback signal V_{FB}. A source of the transistor 110 is coupled to a first terminal of the resistor 115. The resistor 116 is coupled between a second terminal of the resistor 115 and a ground. The signal V_{B} is generated at the joint of the resistors 115 and 116. The signal V_{B} is correlated to the feedback signal V_{FB}. The feedback signal V_{FB} is generated in accordance with the output of the power converter.

The current-sense signal V_{CS} is coupled to a negative input terminal of a comparator 120. The signal V_{B} is coupled to a positive input terminal of the comparator 120 to compare with the current-sense signal V_{CS} for resetting a flip-flop 180 through an output terminal of an AND gate 131 and turning off the switching signal S_{W}. The output terminal of the AND gate 131 is coupled to a reset input terminal R of the flip-flop 180 for resetting the flip-flop 180 and turning off the switching signal S_{W}. In other words, the flip-flop 180 serves as a switching circuit for generating the switching signal S_{W} in accordance with the feedback signal V_{FB} and the output of the power converter. The switching signal S_{W} is coupled to switch the transformer 10 (as shown in FIG. 1) for regulating the output (output voltage V_{O} and/or output current) of the power converter.

A first input terminal of the AND gate 131 is coupled to an output terminal of the comparator 120. A second input terminal of the AND gate 131 is coupled to receive a maximum-duty signal S_{MD}. That is to say, the maximum-duty signal S_{MD} is coupled to the flip-flop 180 through the AND gate 131 to control the maximum on-time (maximum duty cycle) of the switching signal S_{W}. A maximum-duty circuit (T_{ON} MAX) 270 generates the maximum-duty signal S_{MD} in response to the switching signal S_{W} and an under-voltage signal S_{UV}. A third input terminal of the AND gate 131 is coupled to receive an off signal S_{OFF} via an inverter 130. In other words, the switching signal S_{W} can be further controlled by the off signal S_{OH}.

A pulse signal PLS is generated by an oscillator (OSC) 150. The pulse signal PLS is coupled to a clock input terminal CK of the flip-flop 180. That is to say, the flip-flop 180 is enabled by the pulse signal PLS for generating the switching signal S_{W} at an output terminal Q. A pulse generator 300 generates the off signal S_{OFF} in response to the switching signal S_{W}, the under-voltage signal S_{UV} and an over-voltage signal S_{OX}. The under-voltage signal S_{UV} is an option for generating the off signal S_{OFF}.

A sample circuit (V_{O} SAMPLE) 200 is coupled to sample the reflected signal V_{S} of the transformer 10 (as shown in FIG. 1) and generate a sampled signal V_{OX}. The sampled signal V_{OX} is coupled to a positive input terminal of a comparator 125. A negative input terminal of the comparator 125 is coupled to receive a threshold V_{T}. The comparator 125 compares the sampled signal V_{OX} with the threshold V_{T}. The comparator 125 generates (enables) the over-voltage signal S_{OX} when the level of the sampled signal V_{OX} is higher than the threshold V_{T}. The reflected signal V_{S} is correlated to the output voltage V_{O} (as shown in FIG. 1). Therefore, the sampled signal V_{OX} is also correlated to the output voltage V_{O}. It means that the over-voltage signal S_{OX} is generated when the output voltage V_{O} is higher than an over-voltage threshold. The over-voltage threshold is thus related to the threshold V_{T}.

In addition, the over-voltage signal S_{OX} is coupled to the pulse generator 300 for generating the off signal S_{OFF}. Therefore, the sampled signal V_{OX} is coupled to limit the pulse width of the switching signal S_{W} when the output voltage V_{O} is higher than the over-voltage threshold. In other words, the switching circuit (flip-flop 180) generates the switching signal S_{W} in accordance with the sampled signal V_{OX}.

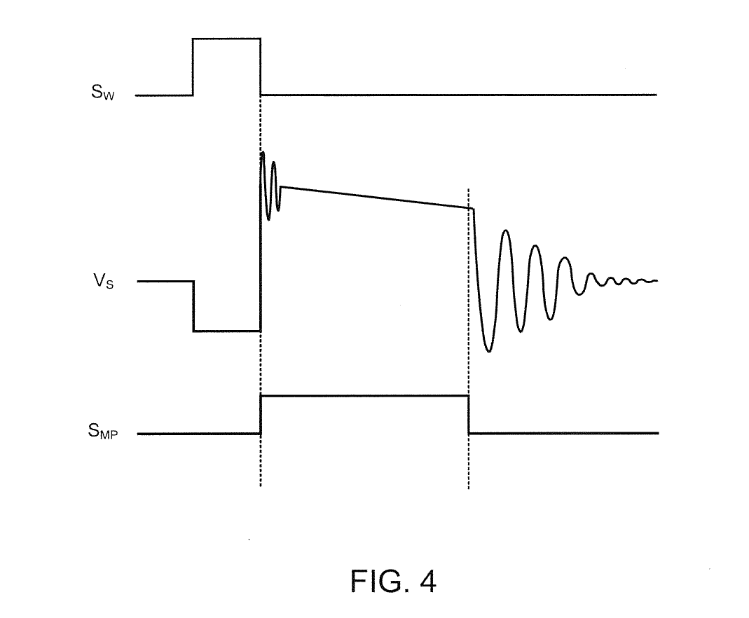

FIG. 4 shows the signal waveforms of the sample circuit 200. The reflected signal V_{S} of the transformer 10 (as shown in FIG. 1) is sampled by the sample circuit 200 after the switching signal S_{W} is turned off. A sample signal S_{MP} is utilized to sample the reflected signal V_{S}. The skill of sampling the signal of the transformer 10, such as the reflected signal V_{S}, can be found in the prior arts “Multiple-sampling circuit for measuring reflected voltage and discharge time of a transformer” U.S. Pat. No. 7,151,681; “Causal sampling circuit for measuring reflected voltage and demagnetizing time of transformer” U.S. Pat. No. 7,349,229; “Linear-predict sampling for measuring demagnetized voltage of transformer” U.S. Pat. No. 7,486,528.

Refer to FIG. 3, the control circuit 100 further comprises a detection circuit 210. The detection circuit 210 is coupled to detect the reflected signal V_{S} for generating a brownout signal S_{BO} and the under-voltage signal S_{UV} in accordance with the input voltage V_{IN} (as shown in FIG. 1). The brownout signal S_{BO} is coupled to an input terminal D of the flip-flop 180 for turning off the switching signal S_{W} during the brownout condition.

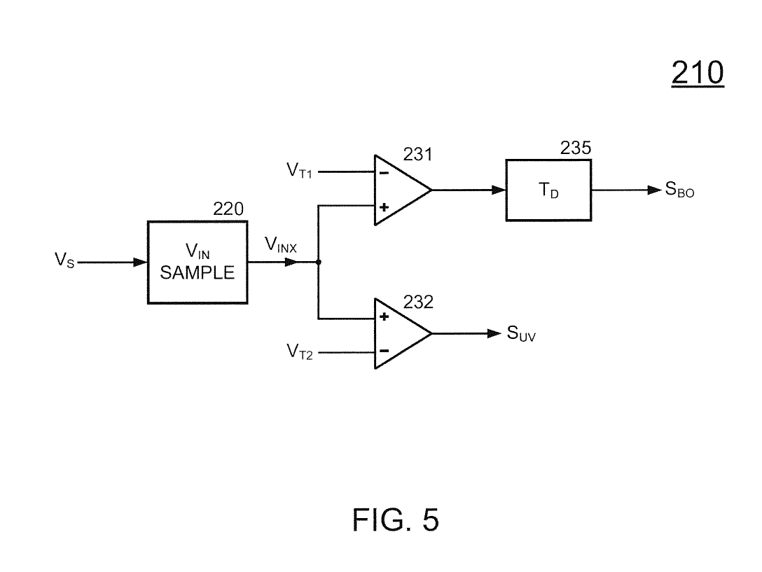

FIG. 5 is a circuit diagram of an embodiment of the detection circuit 210 according to the present invention. It includes a sample unit (V_{IN} SAMPLE) 220, a comparator 231, a comparator 232, and a timer circuit (T_{D}) 235 for detecting the input voltage V_{IN} through the transformer 10 (as shown in FIG. 1) and generating the brownout signal S_{BO} and the under-voltage signal S_{UV}. The sample unit 220 is coupled to sample the reflected signal V_{S} of the transform 10 for generating a sampled signal V_{INX}. The reflected signal V_{S} is also correlated to the input voltage V_{IN}. Therefore, the sampled signal V_{INX} is correlated to the input voltage V_{IN}. The detail operation of the sample unit 220 can be found in the prior art of “Detection circuit for sensing the input voltage of transformer”, U.S. Pat. No. 7,671,578.

The sampled signal V_{INX} is further coupled to the comparator 231 for generating the brownout signal S_{BO} through the timer circuit 235. The sampled signal V_{INX} is coupled to a positive input terminal of the comparator 231. A negative input terminal of the comparator 231 receives a threshold V_{T1}. The comparator 231 compares the sampled signal V_{INX} with the threshold V_{T1}. An output of the comparator 231 is coupled to an input terminal of the timer circuit 235 for generating the brownout signal S_{BO}. The timer circuit 235 ensures the brownout signal S_{BO} can only be generated once the level of the sampled signal V_{INX} is lower than the threshold V_{T1} and this situation over a time period, such as 300 msec. It means that the brownout signal S_{BO} is generated when the input voltage V_{IN} is lower than a brownout threshold. The brownout threshold is thus related to the threshold V_{T1}.

Further, the sampled signal V_{INX} is coupled to a positive input terminal of the comparator 232. A negative input terminal of the comparator 232 receives a threshold V_{T2}. The comparator 232 will generate the under-voltage signal S_{UV} when the level of the sampled signal V_{INX} is lower than the threshold V_{T2}. Therefore, the under-voltage signal S_{UV} is generated when the input voltage V_{IN} is lower than an under-voltage threshold. The under-voltage threshold is related to the threshold V_{T2}. As shown in FIG. 3, the under-voltage signal S_{UV} is coupled to the pulse generator 300 for generating the off signal S_{OFF}. The off signal S_{OFF} is utilized to limit the pulse width of the switching signal S_{W}. In other words, the under-voltage signal S_{UV} is coupled to limit the pulse width of the switching signal S_{W} when the input voltage V_{IN} is lower than the under-voltage threshold.

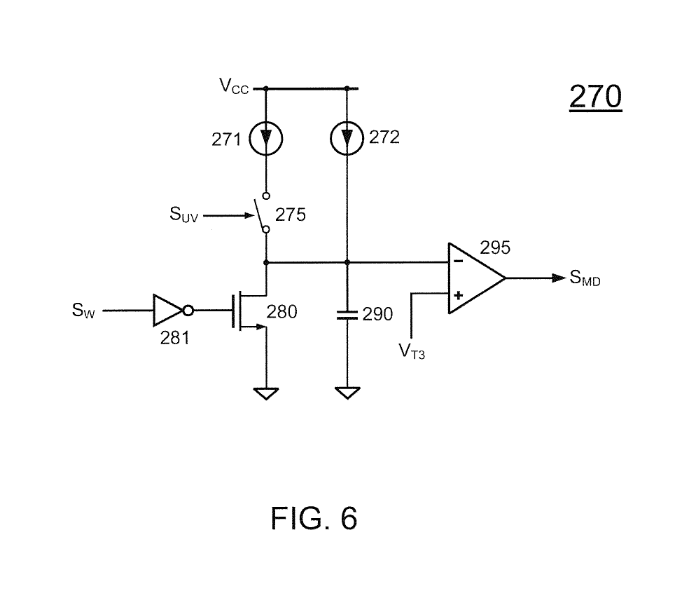

FIG. 6 shows a circuit diagram of an embodiment of the maximum-duty circuit 270 in accordance with the present invention. The maximum-duty circuit 270 comprises two current sources 271, 272, a switch 275, a transistor 280, an inverter 281, a capacitor 290, and a comparator 295. The second current source 272 is coupled between the supply voltage V_{CC} and the capacitor 290. A first terminal of the first current source 271 is also coupled to the supply voltage V_{CC}. The switch 275 is coupled between a second terminal of the first current source 271 and the capacitor 290. A drain of the transistor 280 is coupled to the switch 275, the second current source 272, and the capacitor 290. A source of the transistor 280 is coupled to the ground. The switching signal S_{W} is coupled to a gate of the transistor 280 via the inverter 281 for controlling the transistor 280.

In response to the turn on of the switching signal S_{W}, the first current source 271 is coupled to charge the capacitor 290 via the switch 275. The second current source 272 is also coupled to charge the capacitor 290. A negative input terminal of the comparator 295 is coupled to the capacitor 290. A positive input terminal of the comparator 295 is coupled to a comparing threshold V_{T3}. The comparator 295 compares the voltage of the capacitor 290 with the comparing threshold V₃₃. When the voltage of the capacitor 290 is higher than the comparing threshold V_{T3}, the comparator 295 will disable the maximum-duty signal S_{MD} for turning off the switching signal S_{W} (as shown in FIG. 3). The switching signal S_{W} is further coupled to discharge the capacitor 290 through the transistor 280 and the inverter 281 when the switching signal S_{W} is turned off. The switch 275 is controlled by the under-voltage signal S_{UV}. Therefore, the maximum pulse width (duty cycle) of the switching signal S_{W} is shorter when the under-voltage signal S_{UV} is disabled (the under-voltage signal S_{UV} is a low-true signal) and the switch 275 is turned on. The maximum pulse width of the switching signal S_{W} is wider once the under-voltage signal S_{UV} is enabled (the switch 275 is turned off when the input voltage V_{IN} is low).

When the power converter is operated in BCM and CCM, the output voltage V_{O} can be expressed as,

$${V}_{IN} \times {T}_{ON} = {V}_{O} \times \frac{{N}_{P}}{{N}_{S}} \times ( T - {T}_{ON} ) \\ {V}_{O} = {V}_{IN} \times \frac{{N}_{S}}{{N}_{P}} \times ( \frac{{T}_{ON}}{T - {T}_{ON}} ) \\ \frac{\partial {V}_{O}}{\partial {T}_{ON}} = {V}_{IN} \times \frac{{N}_{S}}{{N}_{P}} \times [ ( \frac{1}{T - {T}_{ON}} ) + \frac{{T}_{ON}}{{( T - {T}_{ON} )}^{2}} ] \\ \frac{\partial {V}_{O}}{\partial {T}_{ON}} = {V}_{IN} \times \frac{{N}_{S}}{{N}_{P}} \times [ \frac{T}{{( T - {T}_{ON} )}^{2}} ] \qquad ( 3 )$$

The equations (1) and (2) show that the output power P_{O} of the power converter is determined by the input voltage V_{IN} and the on-time T_{ON} of the switching signal S_{W}. A higher duty cycle (T_{ON}/T) can increase the output power P_{O} in case a lower input voltage V_{IN}. However, in term of the loop stability, the equation (3) shown the higher duty cycle and/or a higher input voltage V_{IN} will result a high-loop-gain. This high-loop-gain may cause the stability problem for the feedback loop. Therefore, according to the present invention, the maximum-duty circuit 270 will increase the on-time of the maximum-duty signal S_{MD} to increase the maximum on-time (T_{ON}) of the switching signal S_{W} only when the input voltage V_{IN} is low. It means that the control circuit 100 (as shown in FIG. 3) will increase the maximum on-time (maximum duty cycle) of the switching signal S_{W} to reduce the output ripple only when the input voltage V_{IN} is lower than an low-voltage threshold. The low-voltage threshold is related to the threshold V_{T2} (as shown in FIG. 5).

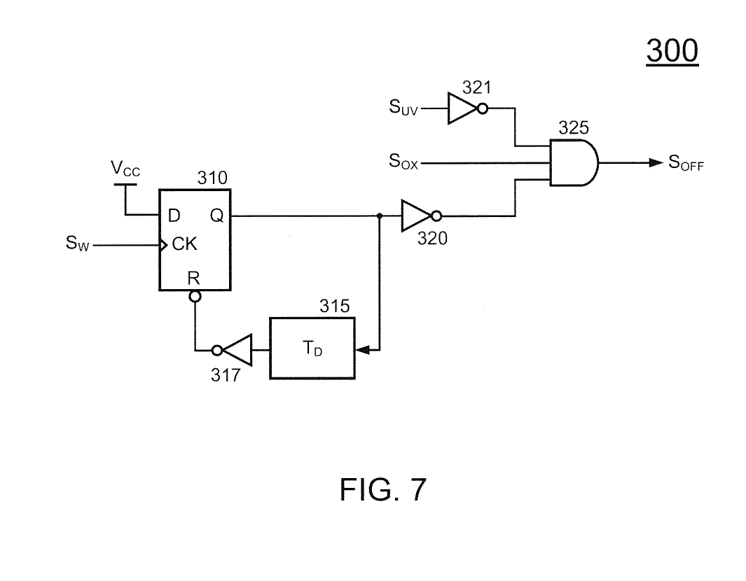

FIG. 7 shows a circuit diagram of an embodiment of the pulse generator 300 in accordance with the present invention. A flip-flop 310, a time-delay circuit 315 (T_{D}), and an inverter 317 develop a pulse circuit and generate a pulse signal in response to the enable (turn on) of the switching signal S_{W}. The pulse signal is generated at an output terminal Q of the flip-flop 310. The delay time of the time-delay circuit 315 determines the pulse width of this pulse signal. An input terminal D of the flip-flop 310 is coupled to receive the supply voltage V_{CC}. The switching signal S_{W} is coupled to a clock input terminal CK of the flip-flop 310. An input terminal of the time-delay circuit 315 is coupled to the output terminal Q of the flip-flop 310. An output terminal of the time-delay circuit 315 is coupled to a reset input terminal R of the flip-flop 310 via the inverter 317.

This pulse signal (the output of the flip-flop 310) is coupled to generate the off signal S_{OFF} through an inverter 320 and an AND gate 325 when the over-voltage signal S_{OX} is generated (enabled). This pulse signal is coupled to a first input terminal of the AND gate 325 through the inverter 320. An output terminal of the AND gate 325 generates the off signal S_{OFF}. The under-voltage signal S_{UV} is coupled to a second input terminal of the AND gate 325 via an inverter 320. The over-voltage signal S_{OX} is coupled to a third input terminal of the AND gate 325. Thus, the off signal S_{OFF} is generated in response to the enable of the switching signal S_{W}, the enable of the over-voltage signal S_{OX}, and the under-voltage signal S_{UV} (an option). Therefore, the off signal S_{OFF} will be generated to turn off the switching signal S_{W} when the output voltage V_{O} is higher than the over-voltage threshold.

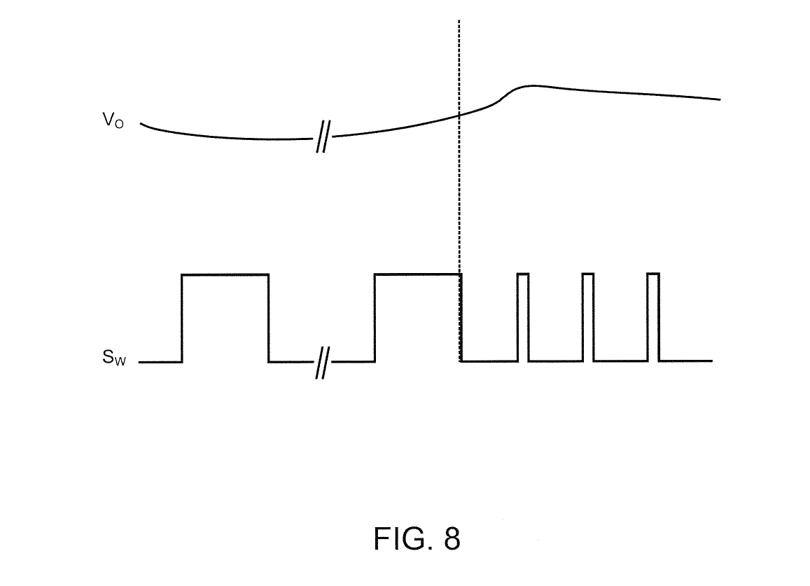

FIG. 8 shows the signal waveforms of the switching signal S_{W} and the output voltage V_{O}. When the output voltage V_{O} of the power converter is higher than the over-voltage threshold, the pulse width of the switching signal S_{W} is limited. That is to say, the switching signal S_{W} is adjusted when the output voltage V_{O} is higher than the over-voltage threshold.

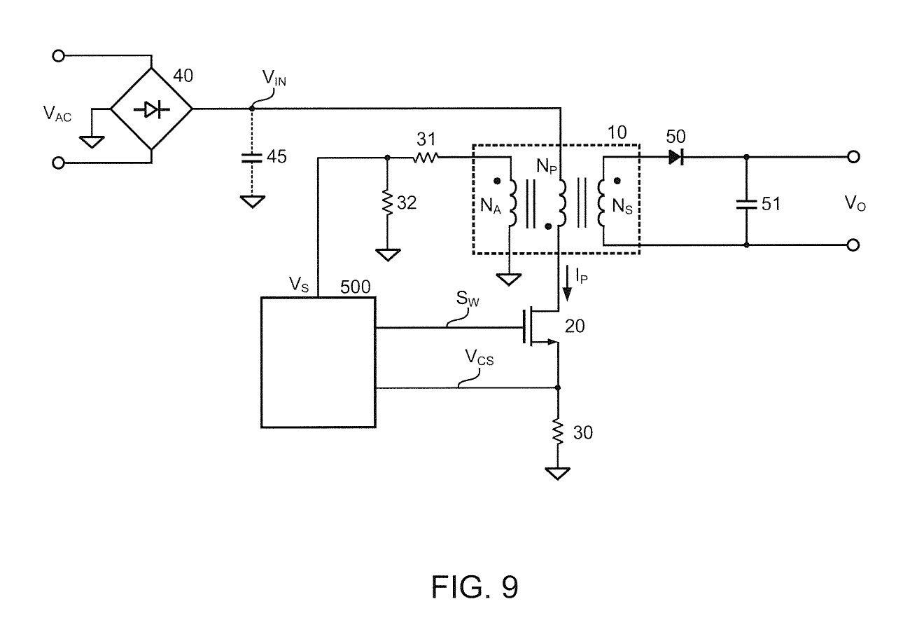

FIG. 9 shows a circuit diagram of applying the control circuit in accordance with the present invention to a primary-side controlled power converter with the small input capacitor. The primary-side controlled power converter does not require the resistor 61, the voltage-regulator 70 and the opto-coupler 75 shown in the FIG. 1. The feedback signal of the primary-side controlled power converter is developed through the resistors 31, 32 and the auxiliary winding N_{A} of the transformer 10. A control circuit 500 generates the switching signal S_{W} by sensing the reflected signal Vs of the auxiliary winding N_{A} of the transformer 10. The control circuit 500 also can be used for the power converter without the input capacitor. Other circuits of the primary-side controlled power converter are the same as the power converter of FIG. 1.

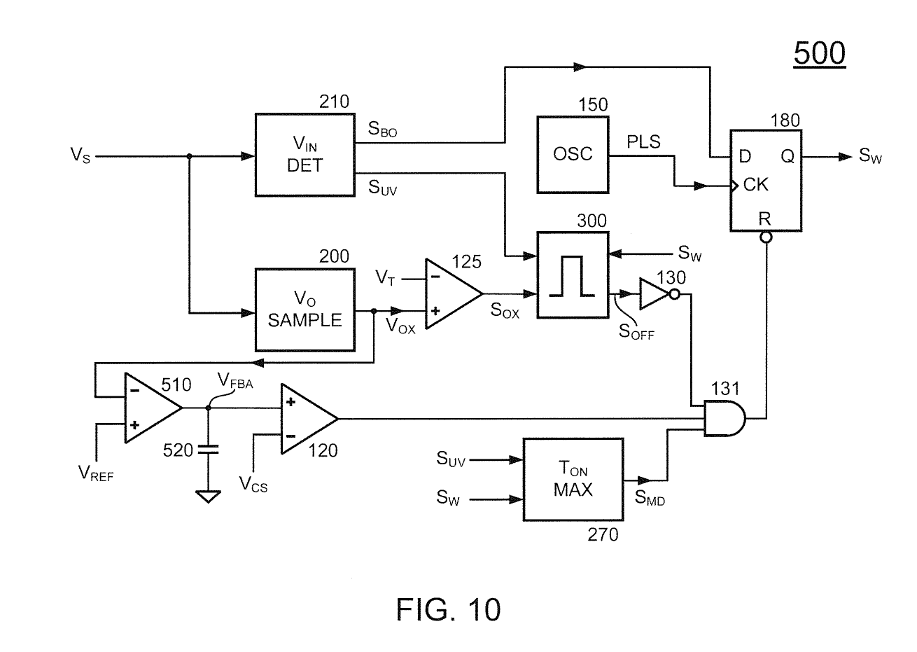

FIG. 10 shows a circuit diagram of an embodiment of the control circuit 500 applied to the primary-side controlled power converter with small input capacitor according to the present invention. The control circuit 500 does not require the level-shift circuit developed by the transistor 110 and the resistors 112, 115, 116 shown in FIG. 3. The control circuit 500 further comprises an error amplifier 510 and a low-pass filter 520. The sample circuit 200 samples the reflected signal V_{S} for generating the sampled signal V_{OX}. The sampled signal V_{OX} is correlated to the output of the primary-side controlled power converter. The sampled signal V_{OX} is coupled to a negative input terminal of the error amplifier 510 for generating a feedback signal V_{FBA}. Therefore, the feedback signal V_{FBA} is generated in accordance with the output of the primary-side controlled power converter. A positive input terminal of the error amplifier 510 receives a reference signal V_{REF}. An output terminal of the error amplifier 510 is coupled to the low-pass filter 520. The low-pass filter 520 is a capacitor according to one embodiment of the present invention.

An output of the error amplifier 510 and the low-pass filter 520 are used to generate the feedback signal V_{FBA}. The feedback signal V_{FBA} is coupled to the positive input terminal of the comparator 120 to compare with the current-sense signal V_{CS} for resetting the flip-flop 180 and turning off the switching signal S_{W}. The switching signal S_{W} can be further turned off by the off signal S_{OFF} when the output voltage V_{O} (as shown in FIG. 9) is higher than the over-voltage threshold. Further, the detail operation of the primary-side controlled power converter can be found in the prior art of “Close-loop PWM controller for primary-side controlled power converters”, U.S. Pat. No. 7,016,204. Other circuits of the control circuit 500 are the same as the control circuit 100 of FIG. 3, so here is no need to describe again.

Although the present invention and the advantages thereof have been described in detail, it should be understood that various changes, substitutions, and alternations can be made therein without departing from the spirit and scope of the invention as defined by the appended claims. That is, the discussion included in this invention is intended to serve as a basic description. It should be understood that the specific discussion may not explicitly describe all embodiments possible; many alternatives are implicit. The generic nature of the invention may not fully explained and may not explicitly show that how each feature or element can actually be representative of a broader function or of a great variety of alternative or equivalent elements. Again, these are implicitly included in this disclosure. Neither the description nor the terminology is intended to limit the scope of the claims.

What is claimed is:

1. A control circuit of a power converter, comprising:
a switching circuit generating a switching signal coupled to switch a transformer of the power converter for regulating an output of the power converter in accordance with a feedback signal and a sampled signal; and
a sample circuit generating the sampled signal by sampling a signal of the transformer;
wherein the feedback signal is generated through an opto-coupler in accordance with the output of the power converter; the sampled signal is correlated to an output voltage of the power converter.

2. The circuit as claimed in claim 1, wherein the sampled signal is coupled to limit the pulse width of the switching signal when the output voltage of the power converter is higher than an over-voltage threshold.

3. The circuit as claimed in claim 1, further comprising a detection circuit coupled to detect an input voltage of the power converter and generate an under-voltage signal when the input voltage of the power converter is lower than an under-voltage threshold; in which the pulse width of the switching signal is limited when the output voltage of the power converter is higher than an over-voltage threshold and the input voltage of the power converter is lower than the under-voltage threshold.

4. The circuit as claimed in claim 3, wherein the detection circuit detects the input voltage of the power converter through the transformer.

5. The circuit as claimed in claim 3, wherein the detection circuit further generates a brownout signal after a time delay when the input voltage of the power converter is lower than a brownout threshold, the brownout signal is coupled to turn off the switching signal.

6. The circuit as claim in claim 1, wherein the maximum duty cycle of the switching signal is increased when an input voltage of the power converter is lower than a low-voltage threshold.

7. The circuit as claim in claim 6, further comprising a maximum-duty circuit generating a maximum-duty signal coupled to control the maximum duty cycle of the switching signal.

8. The circuit as claim in claim 7, wherein the maximum-duty circuit comprises:
a capacitor;
a first current source charging the capacitor;
a second current source charging the capacitor;
a switch coupled between the first current source and the capacitor; and
a comparator comparing a voltage of the capacitor with a comparing threshold for generating the maximum-duty signal;
wherein the switch is turned off when the input voltage of the power converter is lower than the low-voltage threshold; when the voltage of the capacitor is higher than the comparing threshold, the comparator will disable the maximum-duty signal to turn off the switching signal.

9. A controller of a power converter, comprising:
a switching circuit generating a switching signal coupled to switch a transformer of the power converter for regulating an output of the power converter in accordance with a feedback signal and a sampled signal; and
a sample circuit generating the sampled signal by sampling a signal of the transformer;
wherein the feedback signal is generated through an error amplifier and a low-pass filter in accordance with the output of the power converter; the sampled signal is correlated to an output voltage of the power converter.

10. The controller as claimed in claim 9, wherein the sampled signal is coupled to limit the pulse width of the switching signal when the output voltage of the power converter is higher than an over-voltage threshold.

11. The controller as claimed in claim 9, further comprising a detection circuit coupled to detect an input voltage of the power converter and generate an under-voltage signal when the input voltage of the power converter is lower than an under-voltage threshold; in which the pulse width of the switching signal is limited when the output voltage of the power converter is higher than an over-voltage threshold and the input voltage of the power converter is lower than the under-voltage threshold.

12. The controller as claimed in claim 11, wherein the detection circuit detects the input voltage of the power converter through the transformer.

13. The controller as claimed in claim 11, wherein the detection circuit further generates a brownout signal after a time delay when the input voltage of the power converter is lower than a brownout threshold, the brownout signal is coupled to turn off the switching signal.

14. The controller as claim in claim 9, wherein the maximum duty cycle of the switching signal is increased when an input voltage of the power converter is lower than a low-voltage threshold.

15. The controller as claim in claim 14, further comprising a maximum-duty circuit generating a maximum-duty signal coupled to control the maximum duty cycle of the switching signal.

16. The controller as claim in claim 15, wherein the maximum-duty circuit comprises:
a capacitor;
a first current source charging the capacitor;
a second current source charging the capacitor;
a switch coupled between the first current source and the capacitor; and
a comparator comparing a voltage of the capacitor with a comparing threshold for generating the maximum-duty signal;
wherein the switch is turned off when the input voltage of the power converter is lower than the low-voltage threshold; when the voltage of the capacitor is higher than the comparing threshold, the comparator will disable the maximum-duty signal to turn off the switching signal.
